(19) United States
(12) Patent Application Publication
(10) Pub. No.: US 2012/0246154 A1
(43) Pub. Date: Sep. 27, 2012

(54) AGGREGATING SEARCH RESULTS BASED ON ASSOCIATING DATA INSTANCES WITH KNOWLEDGE BASE ENTITIES

(75) Inventors: Songyun Duan, Pleasantville, NY (US); Achille B. Fokoue-Nfoutche, White Plains, NY (US); Oktie Hassanzadeh, Toronto (CA); Anastasios Kementsietsidis, New York, NY (US); Kavitha Srinivas, Rye, NY (US); Michael J. Ward, New Haven, CT (US)

(73) Assignee: INTERNATIONAL BUSINESS MACHINES CORPORATION, Armonk, NY (US)

(21) Appl. No.: 13/070,193

(22) Filed: Mar. 23, 2011

(51) Int. Cl. G06F 17/30

(52) U.S. Cl. 707/728; 707/722; 707/E17.014

(57) ABSTRACT

Methods and systems for aggregating search query results include receiving search query results and schema information for the query results from multiple heterogeneous sources, determining types for elements of the query results based on the schema information, determining potential aggregations for the query results based on the types, which are based on accumulated information from the plurality of heterogeneous resources, and aggregating the query results according to one or more of the potential aggregations.

### RELATED APPLICATION INFORMATION

This application is further related to application serial no. TBD, (Attorney Docket No. YOR920110073US1 (163-397), entitled ANNOTATING SCHEMA ELEMENTS BASED ON ASSOCIATING DATA INSTANCES WITH KNOWLEDGE BASE ENTITIES), filed on concurrently herewith, incorporated herein by reference.

### BACKGROUND

1. Technical Field

The present invention relates to aggregation hierarchies for query results and, in particular, to systems and methods for automatically and dynamically determining aggregation hierarchies based on analysis of query results.

2. Description of the Related Art

Every day, businesses accumulate massive amounts of data from a variety of sources and employ an increasing number of heterogeneous, distributed, and often legacy data repositories to store them. Existing data analytics solutions are not capable of addressing the explosion of data, such that business insights not only remain hidden in the data, but are increasingly difficult to find.

Keyword search is the most popular way of finding information on the Internet. However, keyword search is not compelling in business contexts. Consider, for example, a business analyst of a technology company, interested in analyzing the company's records for customers in the healthcare industry. Given keyword search functionality, the analyst might issue a “healthcare customers” query over a large number of repositories. Although the search will return results that use the word “healthcare” or some derivative thereof, the search would not return, for example, “Entity A” even though Entity A is a company in the healthcare industry. Even worse, the search will return many results having no apparent connection between them. In this case, it would fail to provide a connection between Entity A and Subsidiary B, even though the former acquired the latter.

Although many repositories are available, the techniques for correlating those heterogeneous sources have been inadequate to the task of linking information across repositories in a fashion that is both precise with respect to the users' intent and scalable. Extant techniques perform entity matching in a batch, offline fashion. Such methods generate every possible link, between all possible linkable entities. Generating thousands of links not only requires substantial computation time and considerable storage space, but also requires substantial effort, as the links must be verified and cleaned, due to the highly imprecise nature of linking methods.

### SUMMARY

An exemplary method for aggregating search query results is shown that includes receiving search query results and schema information for the query results from a plurality of heterogeneous sources, determining types for elements of the query results using a processor based on the schema information, determining potential aggregations for the query results based on the determined types to produce aggregations that are based on accumulated information from the plurality of heterogeneous resources, and aggregating the query results according to one or more of the potential aggregations.

A further method for aggregating search query results is shown that includes receiving search query results and schema information for the query results from a plurality of heterogeneous sources, determining types for elements of the query results based on the schema information by lexically analyzing corresponding schema elements, determining potential aggregations for the query results using a processor based on the determined types by combining a plurality of relevancy scores for each said potential aggregation to generate a composite relevancy score for each said potential aggregation and to produce aggregations that are based on accumulated information from the plurality of heterogeneous resources, and aggregating the query results according to one or more of the potential aggregations.

An exemplary system for aggregating search query results is shown that includes a data module configured to receive search query results and schema information for the query results from a plurality of heterogeneous sources, a query module configured to determine potential aggregations for the query results using a processor based on determined types and to produce aggregations that are based on accumulated information from the plurality of heterogeneous resources, comprising a data linker configured to determine types for elements of the query results based on the schema information, and an aggregation module configured to aggregate the query results according to one or more of the potential aggregations.

A further system for aggregating search query results is shown that includes a data module configured to receive search query results and schema information for the query results from a plurality of heterogeneous sources, a query module configured to combine a plurality of relevancy scores for each of a plurality of potential aggregations using a processor to generate a composite relevancy score for each said potential aggregation to produce aggregations that are based on accumulated information from the plurality of heterogeneous resources, comprising a data linker configured to lexically analyze schema elements and determine types for elements of the query results based on the corresponding schema information, and an aggregation module configured to aggregate the query results according to one or more of the potential aggregations.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram that depicts an exemplary data analytics framework.

FIG. 2 is a block/flow diagram that depicts an exemplary method/system for dynamic online aggregation of query results from heterogeneous sources.

FIG. 3 is a block diagram that depicts a hierarchical annotation structure according to the present principles.

### DETAILED DESCRIPTION OF PREFERRED EMBODIMENTS

The usefulness of individual pieces of data is greatly increased when those data are placed into their proper context and interrelated. As data sets increase in size and complexity, and as the number of repositories multiplies, the burden of providing static interrelations between terms becomes unmanageable. Furthermore, a simple keyword-based search will provide far more results than are easily managed. However, the problem may be made tractable by applying a dynamic and context-dependent linking mechanism according to the present principles. User profile metadata, in conjunction with metadata associated with input keywords, is used to link dynamically—in other words, only checking entities which reside in different repositories and are potentially relevant to the current search at query time.

Aggregation of query results based on online analytical processing (OLAP) cubes cannot be directly applied to results from keyword searches over large and extensible sets of data. OLAP cube hierarchies are commonly fixed and are known a priori, during the construction of the cube. Furthermore, the sources and even the data to used to populate the cube are static, such that adding new sources is challenging. The whole cube usually needs to be recomputed.

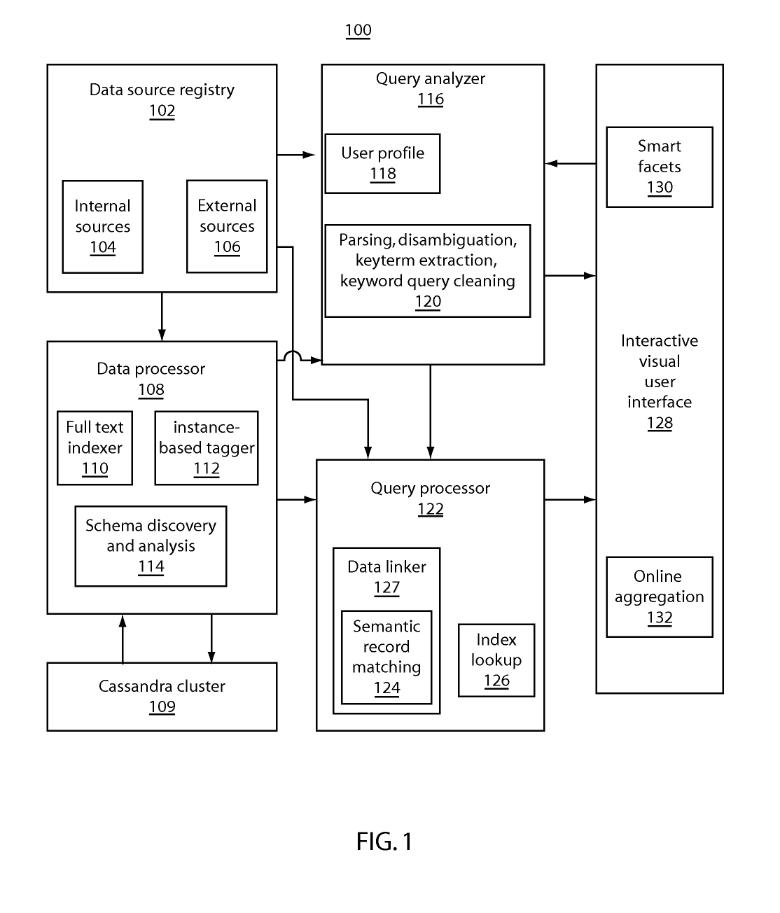

Referring now to FIG. 1, the architecture of a framework 100 for data analytics is shown. A data source registry 102 combines both internal sources 104 and external sources 106 and allows analysis of highly heterogeneous data. Such repositories may contain data of different formats, such as text, relational databases, and XML. The data may further have widely varying characteristics, comprising, for example, a large number of small records and a small number of large records. In addition, the data source registry 102 takes advantage of online data sources 106 with application programming interfaces (APIs) that support different query languages. The data source registry 102 keeps a catalog of available internal 104 and external 106 sources and their access methods and parameters, such as the hostname, driver module (if any), authentication information, and indexing parameters. Users can furthermore add additional sources to the data source registry as needed.

Data processor 108 provides other components in the framework 100 with a common access mechanism for the data indexed by data source registry 102. For internal sources 104, the data processor 108 provides a level of indexing and analysis that depends on the type of data source. Note that no indexing or caching is performed over external sources 106—fresh data is retrieved from the external sources 106 as needed. For internal sources 104, the first step in processing is to identify and store schema information and possibly perform data format transformation. A schema is metadata information that describes instances and elements in a dataset.

The methods described below support legacy data with no given or well-defined schema as well as semi-structured or schema-free data. Toward this end, data processor 108 performs schema discovery and analysis at block 114 for sources without an existing schema. In the case of relational data, the data processor 108 uses instance-based tagger 112 to pick a sample of instance values for each column of a table and issues them as queries to online sources to gather possible “senses” (i.e., extended data type and semantic information) of the instance values of the column. The result is a set of tags associated with each column, along with a confidence value for the tag. Following the healthcare example described above, the instance-based tagger 112 might associate “Entity A” with the type “Company,” or the type “Healthcare Industry,” or another type from some external source. Depending on the implementation, more than one type can be associated with each instance, and multiple types can either be represented as a set or in some hierarchical or graph structure.

Full-text indexer 110 produces an efficient full-text index across all internal repositories. This indexer may be powered by, e.g., a Cassandra (or other variety) cluster 109. Different indexing strategies may be used depending on the source characteristics. For a relational source, for example, depending on the data characteristics and value distributions, the indexing is performed over rows, where values are indexed and the primary key of their tuples are stored, or columns, where values are indexed and columns of their relations are stored. For string values, a q-gram-based index is built to allow fuzzy string matching queries. To identify indexed values, universal resource indicators are generated that uniquely identify the location of the values across all enterprise repositories. For example, indexing the string “Entity A,” appearing in a column “NAME” of a tuple with a primary key CID:34234 in table “CUST,” of source “SOFT_ORDERS,” may result in the URI “/SOFT_ORDERS/CUST/NAME/PK=CID:34234”, which uniquely identifies the source, table, tuple, and column that the value appears in.

A query analyzer 116 processes input search requests, determines the query type, and identifies key terms associated with the input query. The query interface supports several types of queries, ranging from basic keyword-based index lookup to a range of advanced search options. Users can either specify the query type within their queries or use an advanced search interface. The query analyzer 116 performs key term extraction and disambiguation at block 120. The query analyzer 116 further detects possible syntactic errors and semantic differences between a user's query and the indexed data instances and also performs segmentation.

Terms in the query string can be modifiers that specify the type or provide additional information about the following term. To permit individual customization, the query analyzer can employ a user profile 118 that includes information about a user's domain of interest in the form of a set of senses derived from external sources. The user profile 118 can be built automatically based on query history or manually by the user.

Query processor 122 relies on information it receives about a query from the query analyzer 116 to process the query and return its results. The query processor 122 issues queries to the internal index 110, via index lookup 126, as well as online APIs, and puts together and analyzes a possibly large and heterogeneous set of results retrieved from several sources. In addition to retrieving data related to the user's queries, the query processor 122 may issue more queries to online sources to gain additional information about unknown data instances. A data linking module 127 includes record matching and linking techniques that can match records with both syntactic and semantic differences. The matching is performed at block 124 between instances of attributes across the internal 104 and external 106 sources.

To increase both the efficiency and the accuracy of matchings, attribute tags (e.g., “senses”) created during preprocessing are used to pick only those attributes from the sources that include data instances relevant to target attribute values. Once matching of internal and external data is performed, unsupervised clustering algorithms may be employed for grouping of related or duplicate values. The clustering takes into account evidence from matching with external data, which can be seen as performing online grouping of internal data, as opposed to offline grouping and de-duplication. This permits an enhancement of grouping quality and a decrease in the amount of preprocessing needed by avoiding offline ad-hoc grouping of all internal data values.

A user interface 128 provides a starting point for users to interact with the framework. The interface 128 may comprise, e.g., a web application or a stand-alone application. The interface 128 interacts with the query analyzer 116 to guide the user in formulating and fixing a query string. The interface also includes several advanced search features that allow the direct specification of query parameters and the manual building of a user profile 118. In most cases, more than one query type or set of key terms are identified by the query analyzer 116. The query analyzer 116 returns a ranked list of possible interpretations of the user's query string, and the user interface presents the top k interpretations along with a subset of the results. The user can then modify the query string or pick one query type and see the extended results.

The user interface 128 thereby provides online dynamic aggregation and visualization of query results via, e.g., charts and graphs. The interface 128 provides the ability for users to pick from multiple ways of aggregating results for different attributes and data types. A smart facets module 130 can dynamically determine dimensions along which data can be aggregated. The user interface 128 both provides default aggregations along these dimensions, or the interface 128 can present the list of discovered dimensions to the user and let the user pick which dimension to use. After the selection is made, query processor 122 may perform online aggregation.

As an example, consider a user who issues a query string, “healthcare in CUST_INFO,” in an attempt to analyze internal data bout companies in the healthcare industry. The user enters the query into user interface 128, which passes the query to query analyzer 116. The query analyzer 116 then identifies key terms as being “healthcare” and “CUST_INFO” at block 120, and furthermore detects that “healthcare” is an industry and “CUST_INFO” is a data source name in the registry 102. Therefore the analyzer 116 sends two queries to the query processor 122: an index lookup request 126 for the whole query string and a domain-specific and category-specific query (for example “industry:healthcare data-source:CUST_INFO”). For the second query, the query processor 122 issues a request to an external source 106, e.g., the Freebase API, to retrieve all objects associated with object “/en/healthcare” having type “/business/industry”, which includes, among other things, all of the healthcare-related companies in Freebase. The data linking module 127 then performs efficient fuzzy record matching between the records retrieved from Freebase and internal data from external datasource 106 CUST_INFO. For effectiveness, only those internal records are retrieved whose associated schema element is tagged with a proper sense such as “/freebase/business/business_operation” that is also shared with the senses of the objects retrieved from Freebase.

Content management and data integration systems use annotations on schema attributes of managed data sources to aid in the classification, categorization, and integration of those data sources. Annotations, or tags, indicate characteristics of the particular data associated with schema attributes. Most simply, annotations may describe syntactic properties of the data, e.g., that they are dates or images encoded in a particular compression format. In more sophisticated scenarios, an annotation may indicate where the data associated with a schema element fits in, for example, a corporate taxonomy of assets. In existing systems, annotations are either provided directly by humans, by computer-aided analysis of the data along a fixed set of features, or by a combination of these two techniques. These annotation methods are labor intensive and need additional configuration and programming effort when new data sources are incorporated into a management system.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

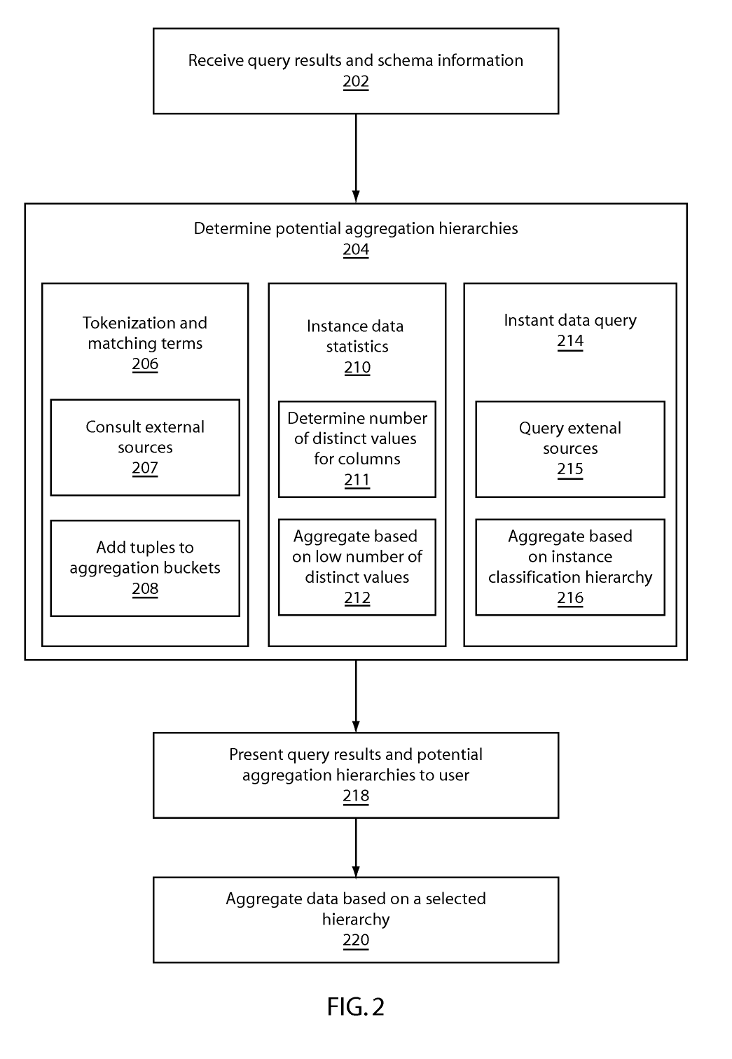

Referring now to FIG. 2, a block/flow diagram is shown of a method for aggregating query results. Query techniques like keyword search and partially structured search (where keywords and phrases are combined with simple Boolean operations) are commonly used to search for information in structured and semi-structured data sets such as relational databases, spreadsheets, and XML documents, as well as in unstructured (plain text) documents. Results from these types of queries over unstructured documents are presented as lists without summarization or aggregation across documents.

After performing a keyword or partially structured search, block 202 accepts the search results and any associated schema or metadata information. These results are used to identify potential aggregation hierarchies in block 204. By determining the semantics of the schemas associated with returned data and identifying type information for the returned data, information can be gleaned about the results that is much more detailed than what is explicitly encoded in the schema definitions in the sources of the data. An exemplary set of query results are shown below in Table 1. These results may come from a single source, or they may come from a plurality of data sources.

TABLE 1

| CUSTOMER | PRODUCT | REPORT_DATE | SEVERITY |
|---|---|---|---|
| 10773524 | Tablet | Oct. 12, 2010 | Medium |
| 63977125 | Laptop | Dec. 24, 2010 | Low |
| 48924001 | Smartphone | Dec. 25, 2010 | High |
| . . . | . . . | . . . | . . . |
| 00091542 | Desktop | Jun. 05, 1999 | Medium |
| 00073866 | Desktop | Apr. 20, 1984 | Low |

There are several ways to use the syntactic and semantic information to determine possible aggregation hierarchies. One or more of the techniques described below may be used. Furthermore, those having ordinary skill in the art will be able to devise other embodiments that fall within the present principles. One exemplary method for determining potential aggregations includes using a tokenization of a column name to identify sub-strings that match well-known terms, shown as block 206. Each term is then used as input to a search that consults dictionaries, taxonomies, and/or external sources to determine type information pertaining to the terms in block 207. For example, if the name of a column is “REPORT_DATE”, syntactic analysis of the column name will identify the term “date.” This term is then used as a query term that is sent to a set of external sources (e.g., DBpedia, Freebase, etc). Some of these sources will return type information for “date,” including the classification and position of “date” in existing ontologies. These ontologies are then used to determine that dates are organized in, e.g., years, months, weeks, and days and the parts of these external ontologies that pertain to dates are used as a potential aggregation hierarchy.

As another example of the tokenization/matching of block 206, consider a column having the name “zip code” in a dataset storing information about store sales. An analysis similar to the above identifies external sources that contain information relating to “zip code”, including geographical ontologies that aggregate zip code by cities, counties, states, etc. These aggregation hierarchies become part of the suggested hierarchies returned to the user. So, instead of merely being given options relating to sorting by zip code, the user will have the option of organizing the data by states or cities. In this way, the determination of aggregation hierarchies in block 206 is performed dynamically in response to the syntactic and semantic information received from external sources.

So, if the user decides to aggregate sales by city, zip code information is retrieved from each tuple of the sales data and sent to an external source that maps zip codes to cities in block 207. For each new city returned by the external source, a new aggregation bucket is created having the sale tuple in block 208. For each previously returned city, block 208 adds the sale tuple to its existing corresponding bucket.

Another possible aggregation method includes gathering statistics about instance data in the query results, as shown in block 210. Using the example of Table 1 above, consider the “SEVERITY” column. Block 211 determines that the number of distinct values in the SEVERITY column is small (e.g., “low”, “medium”, and “high”). This indicates that the column is enumerated in some fashion, presenting an intuitive category for aggregation. The query results may then be aggregated according to the SEVERITY category in block 212, allowing the user to select for example only those results which are of “high” severity.

It is possible to make the determination of a “small” number of distinct values absolutely as well as relatively. In an absolute determination, block 211 determines whether a number of distinct values falls below a predetermined threshold. In a relative determination, block 211 assesses the number of distinct values for each column relative to the other columns. For example, consider a table that has two columns, one with ten distinct values, the other with one thousand distinct values. If one column has a number of distinct values that is, for example, an order of magnitude lower than the others, block 211 could suggest aggregation based on that dimension. This analysis may be performed without any understanding of the semantics of the different fields or of particular instance values.

Another exemplary aggregation method includes using instance data to determine aggregation hierarchies, as shown by block 214. Block 216 queries external databases for the terms of instances within a column. For each of the terms, type information is used to correlate across all the terms, thereby deriving an aggregation hierarchy for the entire column. For example, consider a column that has the entries, “Megatech US,” “CellPlus Europe,” “Searches Inc,” “BankBank,” and “CreditDepot.” Using external sources shows that “Megatech US” is a branch of Megatech, an IT company, while CellPlus Europe is a branch of CellPlus, a telecom. Both Megatech and CellPlus are classified as software companies, and so is Searches Inc. On the other hand, BankBank and CreditDepot are both financial institutions, and all five companies can be classified as large corporations. Each term has its own classification hierarchy and, by combining all term classification hierarchies, a hierarchy for the entire column can be determined. Unlike block 206, where schema information and value mappings are used to perform classification, block 214 uses instance data and their relationships to an external type system to perform aggregation.

The aggregation methods are not mutually exclusive and may be performed in combination. Because block 204 determines potential aggregations, the results of blocks 206, 210, and/or 214 may be combined along with other aggregation techniques according to the present principles. Each of the methods of blocks 206, 210, and 214 may be used to produce a score for each aggregation. The score of each block may be weighted and combined to produce a total score for each aggregation. Depending on the application and user preferences, aggregations rated by the instance data query 214 may be more heavily weighted than aggregations rated by tokenization and matching 206. This flexibility allows users to customize search processing and aggregation according to their own tastes. Information relating to these preferences may be stored, for example, in user profile 118.

After potential aggregation hierarchies have been generated at block 204, they are presented to a user for review and selection in block 218. In this fashion, the user may select the aggregation most pertinent to the desired search. Block 220 then aggregates the data according to the user's selection and presents the query results accordingly.

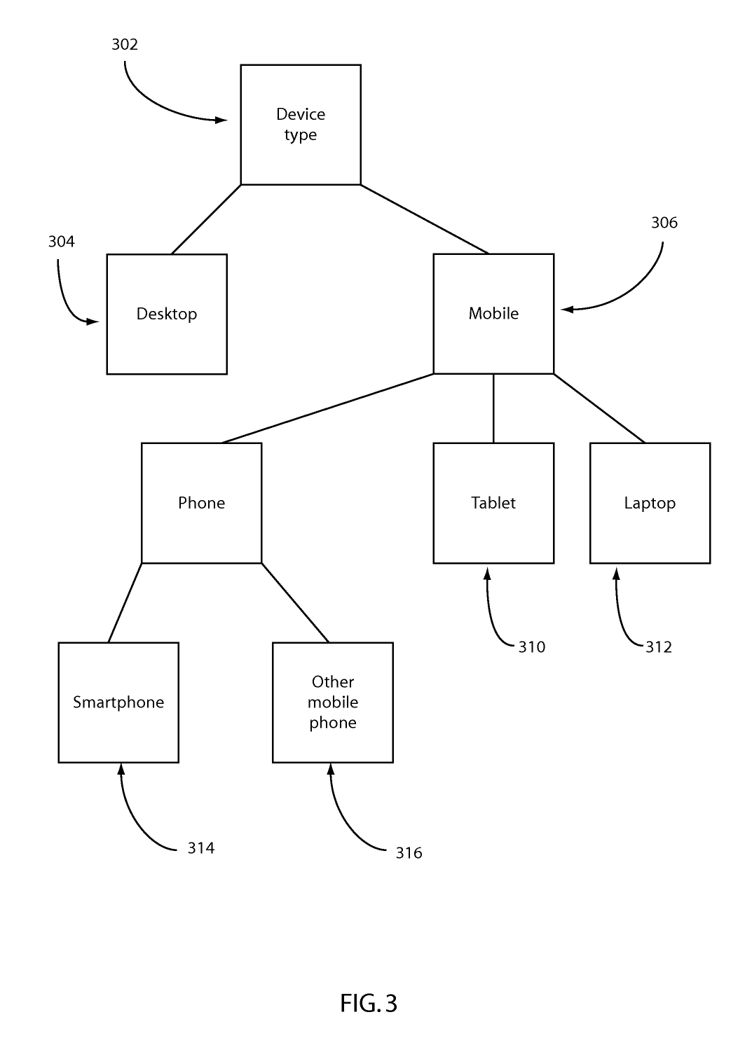

Referring now to FIG. 3, a hierarchical structure for aggregation categories is shown. Consider the above example shown in Table 1, where the user searches for customer data. Possible aggregation categories could include “severity,” “device type,” and “date.” By selecting “device type” 302, for example, a user would receive customer records grouped together according to what kind of device is involved. Exemplary aggregation categories in that case would be “desktop” 304 and “mobile” 306. The “mobile” 306 category, in turn, could have related subcategories of “phone” 308, “tablet” 310, and “laptop” 312. The “phone” 308 category could be further subdivided into “smartphone” 314 and all other mobile phones 316. The user would have the ability, using the user interface 128, to navigate through these and other categories of aggregation to find the most appropriate search results. Similarly, the hierarchical structure of FIG. 3 may be used to combine types to generate higher-level aggregations. For example, if two instances have a shared super-type, such as tablet 310 and laptop 312, they can be combined into the super-type, e.g., mobile 306.

The smart facets module 130 of the user interface 123 can automatically determine aggregations to provide dynamically. The smart facets module 130 may automatically select an aggregation dimension according to any of the aggregation methods shown in FIG. 2 to provide the aggregations that are most likely to be useful and relevant to the user. Furthermore, the interface 128 may access a user profile 118 to find information such as job role, corporate associations, and previous aggregation selections. For example, if the user works in quality assurance, the smart facets module 130 may automatically select “severity” as being most pertinent. Alternatively, if a user habitually searches for records falling within certain date ranges, date aggregation might be automatically selected.

Having described preferred embodiments of a system and method for aggregating search results based on associating data instances with knowledge base entities (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method for aggregating search query results, comprising:
receiving search query results and schema information for the query results from a plurality of heterogeneous sources;
determining types for elements of the query results based on the schema information;
determining potential aggregations for the query results using a processor based on the types, which are based on accumulated information from the plurality of heterogeneous resources; and
aggregating the query results according to one or more of the potential aggregations.

2. The method of claim 1, wherein determining types includes lexically analyzing corresponding schema elements.

3. The method of claim 1, wherein determining types includes analyzing a range of values of corresponding schema elements.

4. The method of claim 3, wherein determining potential aggregations includes selecting potential aggregations based on the range of distinct values in a given element.

5. The method of claim 4, wherein a potential aggregation is selected if the range of distinct values in the given element is below a predetermined threshold.

6. The method of claim 4, wherein a potential aggregation is selected if the range of distinct values in the given element is at least an order of magnitude smaller than the ranges of distinct values of other elements.

7. The method of claim 1, wherein determining types includes retrieving type information for instances of corresponding schema elements.

8. The method of claim 1, wherein determining types includes establishing hierarchical relationships between corresponding schema elements.

9. The method of claim 8, wherein determining types further includes combining types such that types sharing a super-type are merged into the super-type.

10. The method of claim 1, wherein determining potential aggregations includes generating a relevancy score for each potential aggregation.

11. The method of claim 10, wherein determining potential aggregations further includes generating composite relevancy score for each potential aggregation by combining a plurality of relevancy scores for each said potential aggregation.

12. A method for aggregating search query results, comprising:
receiving search query results and schema information for the query results from a plurality of heterogeneous sources;
determining types for elements of the query results based on the schema information by lexically analyzing corresponding schema elements;
determining potential aggregations for the query results based on the types, which are based on accumulated information from the plurality of heterogeneous resources, using a processor by combining a plurality of relevancy scores for each said potential aggregation to generate a composite relevancy score for each said potential aggregation; and
aggregating the query results according to the composite relevancy scores of the potential aggregations.

13. A computer readable storage medium comprising a computer readable program, wherein the computer readable program when executed on a computer causes the computer to:
receive search query results and schema information for the query results from a plurality of heterogeneous sources;
determine types for elements of the query results based on the schema information;
determine potential aggregations for the query results based on the types, which are based on accumulated information from the plurality of heterogeneous resources; and
aggregate the query results according to one or more of the potential aggregations.

14. A system for aggregating search query results, comprising:
a data module configured to receive search query results and schema information for the query results from a plurality of heterogeneous sources;
a query module configured to determine potential aggregations for the query results based on determined types, which are based on accumulated information from the plurality of heterogeneous resources, using a processor, said query module comprising a data linker configured to determine types for elements of the query results based on the schema information; and
an aggregation module configured to aggregate the query results according to one or more of the potential aggregations.

15. The system of claim 14, wherein the query processor is further configured to lexically analyze corresponding schema elements.

16. The system of claim 14, wherein the query processor is further configured to analyze a range of values of corresponding schema elements.

17. The system of claim 16, wherein the query processor is further configured to select potential aggregations based on the range of distinct values in a given element.

18. The system of claim 17, wherein a potential aggregation is selected if the range of distinct values in the given element is below a predetermined threshold.

19. The system of claim 17, wherein a potential aggregation is selected if the range of distinct values in the given element at least an order of magnitude smaller than the ranges of distinct values of other elements.

20. The system of claim 14, wherein the query processor is further configured to retrieve type information for instances of corresponding schema elements.

21. The system of claim 14, wherein the query processor is further configured to establish hierarchical relationships between corresponding schema elements.

22. The system of claim 21, wherein the query processor is further configured to combine types such that types sharing a super-type are merged into the super-type.

23. The system of claim 14, wherein the query processor is further configured to generate a relevancy score for each potential aggregation.

24. The system of claim 23, wherein the query processor is further configured to generate composite relevancy score for each potential aggregation by combining a plurality of relevancy scores for each said potential aggregation.

25. A system for aggregating search query results, comprising:
a data module configured to receive search query results and schema information for the query results from a plurality of heterogeneous sources;
a query module configured to combine a plurality of relevancy scores for each of a plurality of potential aggregations using a processor to generate a composite relevancy score for each said potential aggregation, comprising a data linker configured to lexically analyze schema elements and determine types for elements of the query results based on the corresponding schema information on accumulated information from the plurality of heterogeneous resources; and
an aggregation module configured to aggregate the query results according to the composite relevancy scores of the potential aggregations.
